(19) United States
(12) Patent Application Publication
(10) Pub. No.: US 2013/0339117 A1
(43) Pub. Date: Dec. 19, 2013

(54) SYSTEMS AND METHODS OF INCENTIVIZING GIFTING

(71) Applicant: Linkabale Networks, Inc., Boston, MA (US)

(72) Inventors: David W. Chapman, Norwell, MA (US); Thomas J. Burgess, Portsmouth, RI (US); Francis Correra, Andover, MA (US); Judy C. Frank Duff, Waltham, MA (US); Thomas C. Haley, Charlestown, MA (US); Douglas M. Spear, JR., Newport, RI (US)

(21) Appl. No.: 13/916,544

(22) Filed: Jun. 12, 2013

Related U.S. Application Data
(60) Provisional application No. 61/660,500, filed on Jun. 15, 2012.
(60) Provisional application No. 61/790,056, filed on Mar. 15, 2013.

(51) Int. Cl. G06Q 30/02

(52) U.S. Cl. CPC G06Q 30/0222
USPC 705/14.23

(57) ABSTRACT

A system and method allows a consumer to gift an incentive and/or offer to a recipient, which can be applied to a transaction conducted by the recipient. The incentives are given and redeemed without requiring issuance or utilization of a gift card that is distinct from payment instruments (such as a debit or credit card) utilized by the recipient prior to receiving the incentive. Instead, the monetary value of the incentive given by the purchaser is transferred from an account owned by the purchaser to an intermediate account owned by a third party. When the recipient redeems the incentive, the monetary value of the incentive is automatically transferred from the intermediate account to an account owned by the recipient. In this manner, the purchaser does not have to give either a physical or virtual incentive card and hence, the incentive is not subject to gift card regulations.

### RELATED APPLICATIONS

This application claims benefit of priority to U.S. Provisional Patent Application No. 61/660,500, filed on Jun. 15, 2012 and entitled “Systems and Methods of Incentivizing Transactions”; and U.S. Provisional Patent Application No. 61/790,056 filed on Mar. 15, 2013 and entitled “Systems and Methods of Incentivizing Gifting”, the entire contents of both applications being incorporated herein by reference in their entirety.

### TECHNICAL FIELD

The present application is generally directed to a method and system for a consumer (i.e. purchaser) to gift an incentive and/or offer to a third party recipient, and for processing and redeeming the gifted incentive. The system includes a linked offer gateway or incentive processing system that makes available incentives to a purchaser and links the gifted incentives to a third party account for redemption by a third party recipient of the gifted incentive.

### BACKGROUND

Gift cards have become a popular form of gift giving as they offer flexibility to the recipient. Gift cards typically have a predetermined value and may be purchased from a merchant by a consumer who pays for the card. The purchaser then gives the gift card to the recipient. The recipient, now a cardholder, can then redeem the value on the gift card at the merchant for goods or services. In this scenario, the gift card acts in much the same manner as a gift certificate. To redeem or use the gift card, the recipient presents the gift card to the merchant to pay for a transaction. The payment due for the transaction is then deducted from the gift card.

Because of the convenience and flexibility of gift cards, merchants also use gift cards to provide consumers with rebates, discounts, in-store credit, and other promotions. For example, a merchant may offer a gift card having a certain monetary value with any transaction that has a minimum value. In another example, a merchant may offer a gift card as a reward for loyalty, or on special occasions such as birthdays, or as a reward for meeting certain criteria. In these scenarios, the gift cards act as promotional items.

One drawback in using a gift card is that the gift card needs to be carried by the recipient so that it is available to be presented to the merchant. This can be cumbersome, especially if the recipient has multiple gift cards to redeem. Another problem associated with gift cards are recent regulatory restrictions that have been placed on gift cards. In 2009, Congress passed the Credit Card Accountability Responsibility and Disclosure (CARD) Act, which set consumer protections for gift cards. The law provides that gift cards cannot expire within five years from the date they were activated and generally limits inactivity fees on gift cards except in certain circumstances, such as if there has been no transaction for at least 12 months. In addition, some states require merchants to turn over the value of unused gift cards after a specified amount of time. While the most consumer friendly states do not consider gift cards as unclaimed property, several states specifically include gift cards. Thus, after a certain amount of time the value of the cards are turned into the states unclaimed property division. These restrictions have made gift cards less attractive.

### SUMMARY

Some aspects disclosed herein provide a facility and system for a consumer to gift an incentive and/or offer to a recipient, which can be applied to a transaction conducted by the recipient. According to these aspects, incentives are given and redeemed without requiring issuance or utilization of a payment instrument, for example a gift card, that is distinct from payment instruments (such as a debit or credit card) utilized by the recipient prior to receiving the incentive.

Instead of issuing a gift card, the monetary value of an incentive given by the purchaser is transferred from an account owned by the purchaser to an intermediate account owned by a third party. When the recipient redeems the incentive, the monetary value of the incentive is automatically transferred from the intermediate account to an account owned by the recipient. In this way, at least some of the aspects and embodiments described herein do not require the purchaser to give either a physical or virtual incentive card and are not subject to incentive card regulations or legal obligations. Instead, in at least one embodiment, a credit card or a debit card account (or other payment instrument) of the recipient of the incentive is associated, or linked with the incentive. According to this embodiment, when the incentive is redeemed, the credit card or the debit card account of the recipient is automatically credited with the monetary value of the incentive. In addition, in this embodiment if the incentive is never redeemed it can be credited back to the purchaser or be donated to a third party, for example a charity, at the choice of the purchaser.

Other aspects disclosed herein provide a facility and system for a third party, such as a merchant, to establish a collection of potential incentives that may be given by the purchaser (i.e. the gifter). These incentives may be subject to a variety of terms and conditions that define requirements for redemption of the incentives and that define monetary values awarded at redemption. The terms and conditions may define these monetary values based on wide range of criteria. According to these aspects, a third party, such as the merchant or another interested party may also add monetary value to an incentive previously purchased. The added monetary value may be conditioned on one or more requirements being fulfilled, or may be a function of the relationship of the merchant to the purchaser. For example, a merchant may specify a monetary value that will be added to a previously purchased incentive where the recipient redeems the incentive at a merchant location specified by the merchant, or where the recipient redeems the incentive by purchasing a particular product of the merchant. Alternatively, if the purchaser is a member of a rewards program of the merchant, the purchaser may have rewards that can be added to the value of the incentive. These rewards may be monetary, or may be in the form of a gift, such as a free product. Thus, at least some aspects and embodiments disclosed herein provide access to a stream of commerce that ordinarily is not open for external access.

Other aspects disclosed herein provide a facility for a group of purchasers to combine funds to increase the monetary value of an incentive. This facility may also track the monetary value funded by each member of the group, thereby motivating group members to contribute to a common cause.

Other aspects disclosed herein allow a merchant to provide different incentives to different purchasers based upon the profile of the purchaser. In one embodiment, a loyalty or reward program may reward a purchaser who gifts a certain amount of incentives, either in dollar value or quantity, by making certain special incentives available to that purchaser. The incentives may be rewards to the purchaser, the recipient or a third party, for example a charity. The rewards may be automatically credited to the purchaser, recipient or third party either upon purchase or by linking the reward to the redemption of the incentive. In addition, the purchaser can move up in standing in the rewards or loyalty program by achieving certain criteria set by the merchant, thus having access to incentives not available to other purchasers.

According to at least one embodiment, a computer system is provided. The computer system includes a memory, at least one processor coupled to the memory, a purchaser interface component, a recipient interface component, and an incentive engine component. The purchaser interface component is executed by the at least one processor and is configured to receive a request from a user interface to purchase an incentive having a redemption amount and which may also be subject to a redemption condition. The recipient interface component is executed by the at least one processor and is configured to receive a request to link the incentive to an electronic method of payment when the recipient activates or redeems the incentive. The incentive engine component is executed by the at least one processor and is configured to determine that any redemption condition is satisfied and request that the electronic method of payment be credited by the redemption amount.

According to another embodiment, a method of managing incentives using a computer system is provided.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a context diagram of an incentive processing system;

FIG. 2 is a schematic diagram of the incentive management system illustrated in FIG. 1;

FIG. 3 is a schematic diagram of one example of a computer system that may perform processes and functions disclosed herein;

FIG. 4 is an illustration of a screen provided by a purchaser interface component;

FIG. 5 is an illustration of another screen provided by the purchaser interface component;

FIG. 6 is an illustration of a screen provided by a recipient interface component;

FIG. 7 is a flow diagram illustrating a process of managing incentives; and

FIG. 8 is a flow diagram illustrating a process of identifying leads.

### DETAILED DESCRIPTION

Some of the aspects and embodiments disclosed herein describe new apparatus and processes of incentivizing transactions. For instance, according to some embodiments, a computer system executes components that enable a user (e.g. a purchaser) to provide a purchase incentive to another user (e.g. a recipient). In these embodiments, this purchase incentive gives the recipient monetary value in response to the recipient conducting a transaction. The monetary value endowed by the incentive may originate from the purchaser of the incentive or may originate from other users of the computer system (e.g., a merchant). In some embodiments, the computer system provides the monetary value of an incentive to a recipient in the form of a credit to the recipient in response to the recipient redeeming the incentive (e.g., initiating a purchase transaction having one or more predefined attributes using an identified or linked method of payment). In other embodiments, the computer system augments the monetary value of an incentive in response to an accepted invitation from the purchaser of the incentive to contribute to the incentive or in response to a request by another party to contribute to the incentive.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Terms may also be used interchangeably, for example “purchaser”, “consumer” and “gifter” are all used to refer to a party that is giving an offer or incentive to another party who may be referred to as the “recipient”, “third party” or other similar descriptive term.

### Incentive Processing System

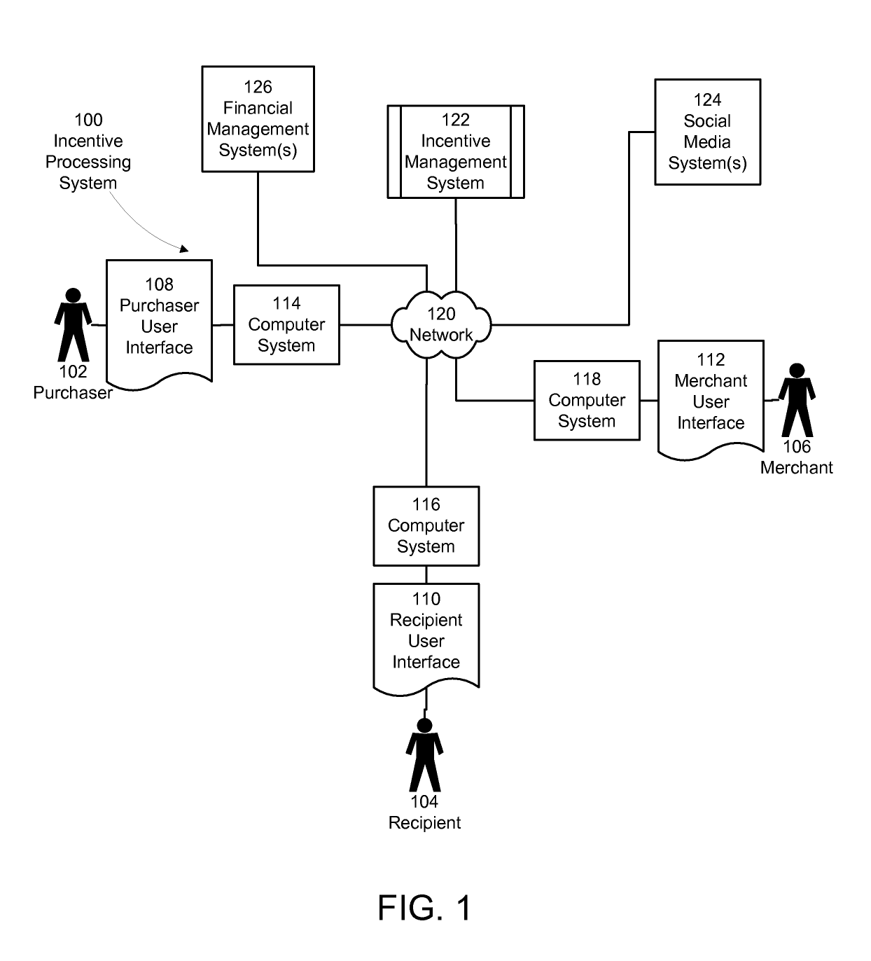

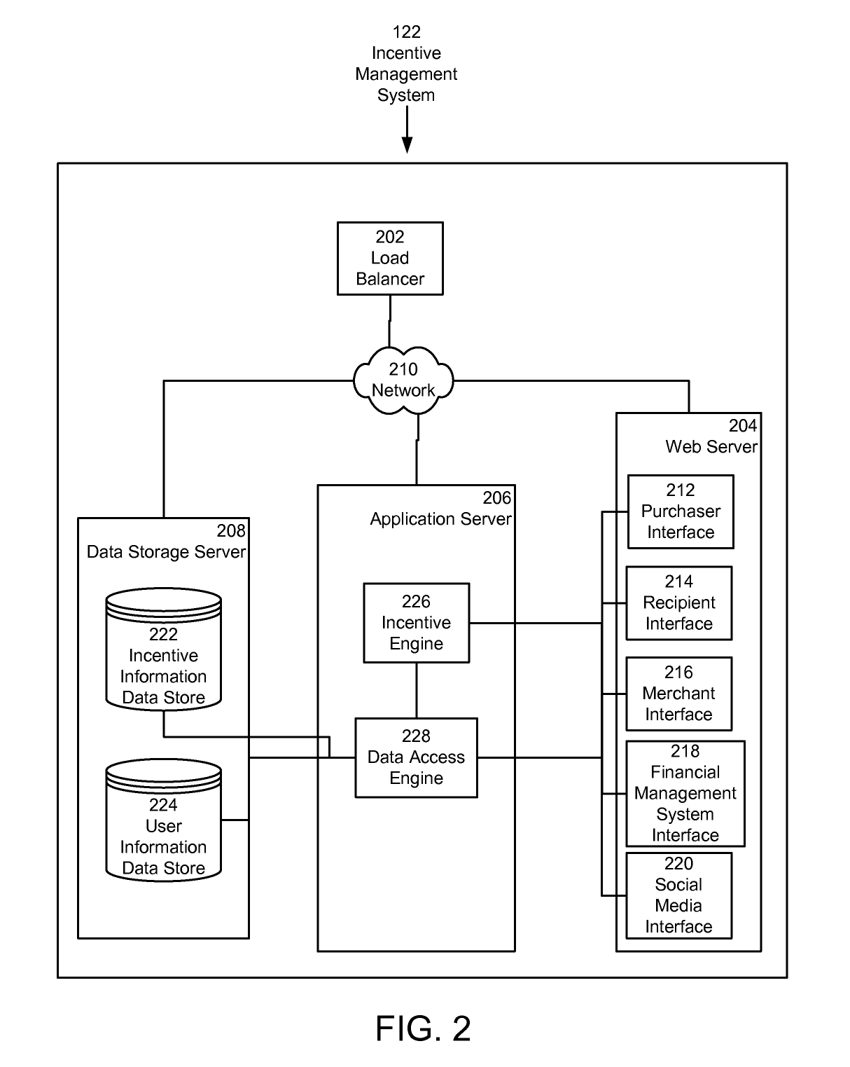

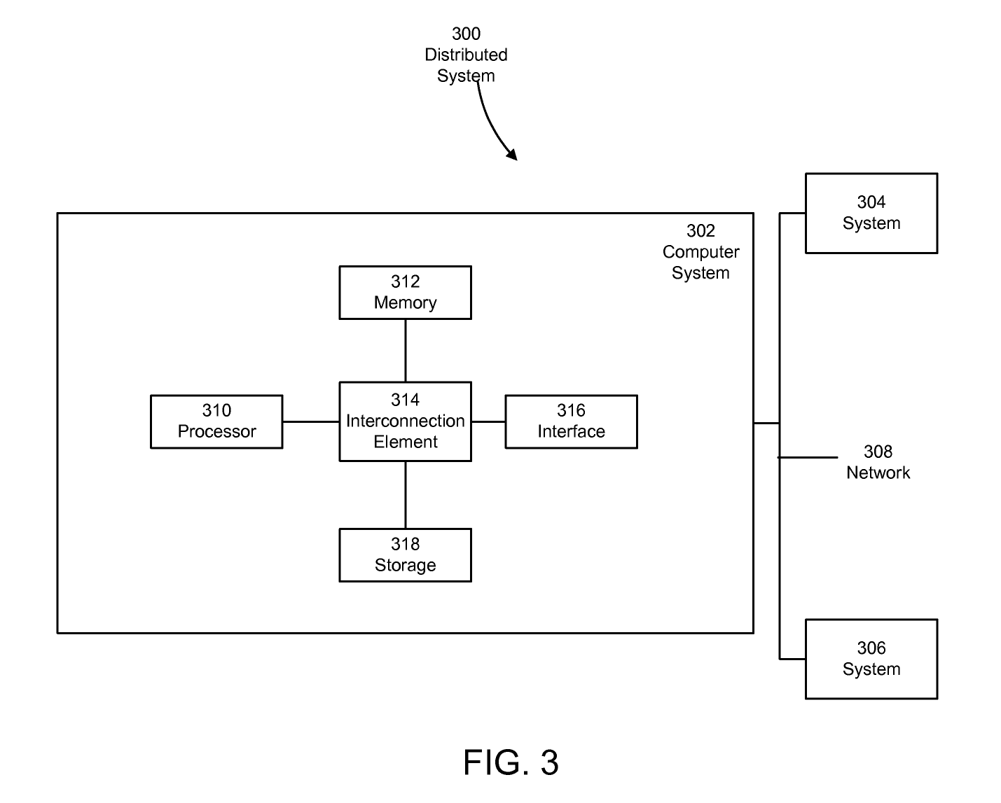

Some embodiments disclosed herein implement an incentive processing system using one or more computer systems, such as the computer systems described below with reference to FIG. 3. According to these embodiments, an incentive processing system generates, stores, tracks, records and verifies redemption of incentives to conduct purchase transactions. FIG. 2 illustrates an exemplary incentive management system 122 within the context of an exemplary incentive processing system 100 (FIG. 1). As shown in FIG. 1, the incentive processing system 100 includes a purchaser 102, a recipient 104, a merchant 106, a purchaser user interface 108, a recipient user interface 110, a merchant user interface 112, computer systems 114, 116, and 118, a communications network 120, the incentive management system 122, social media systems 124, and financial management system(s) 126. The purchaser 102 may interact (e.g., provide or receive information) with the purchaser user interface 108. The recipient 104 may interact with the recipient user interface 110. The merchant 106 may interact with the merchant user interface 112.

As depicted in FIG. 1, the computer systems 114, 116, and 118, the incentive management system 122, the social media systems 124, and the financial management systems 126 exchange (i.e. transmit or receive) information via the network 120. The network 120 may include any communication network through which computer systems exchange information. For example, the network 120 may be a public network, such as the internet, and may include other public or private networks such as LANs, WANs, extranets, intranets, and cloud computing systems. Although shown as a single network in FIG. 1, in some embodiments, the network 120 includes a plurality of communication networks.

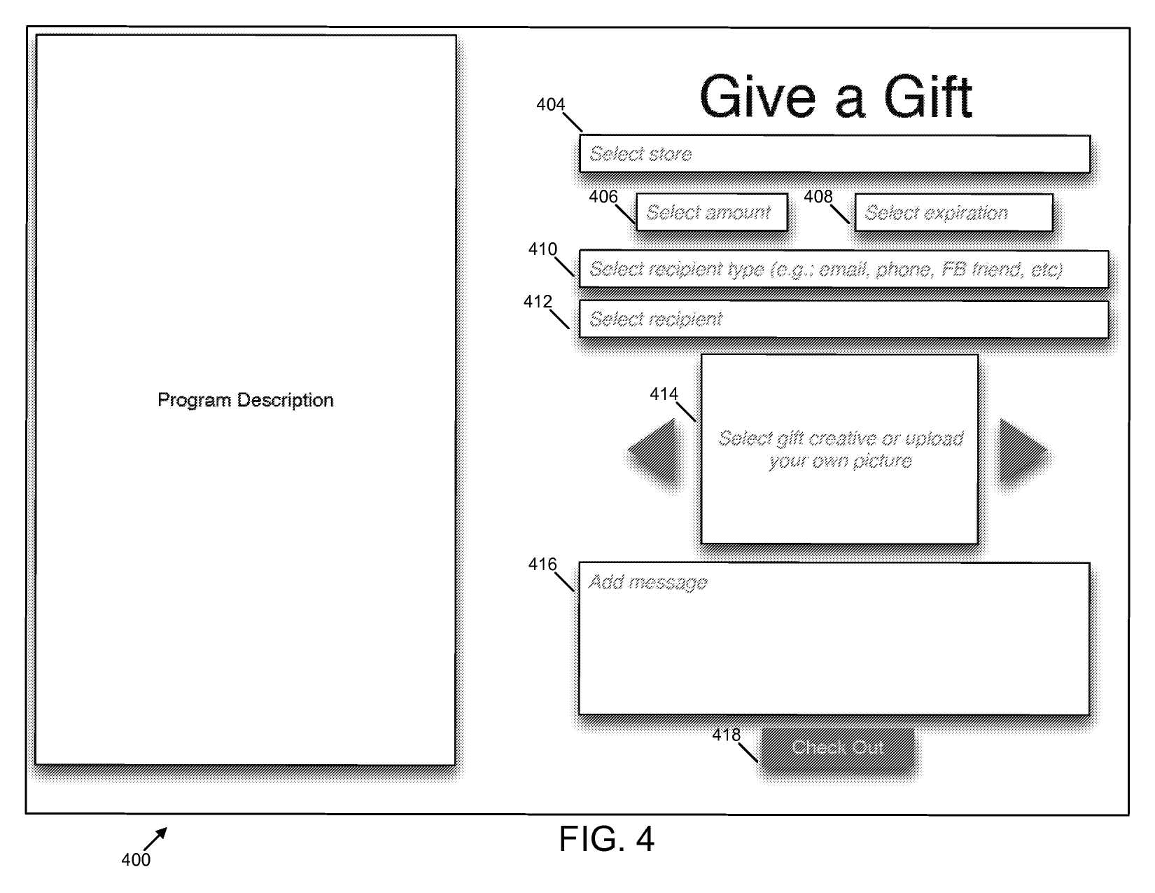

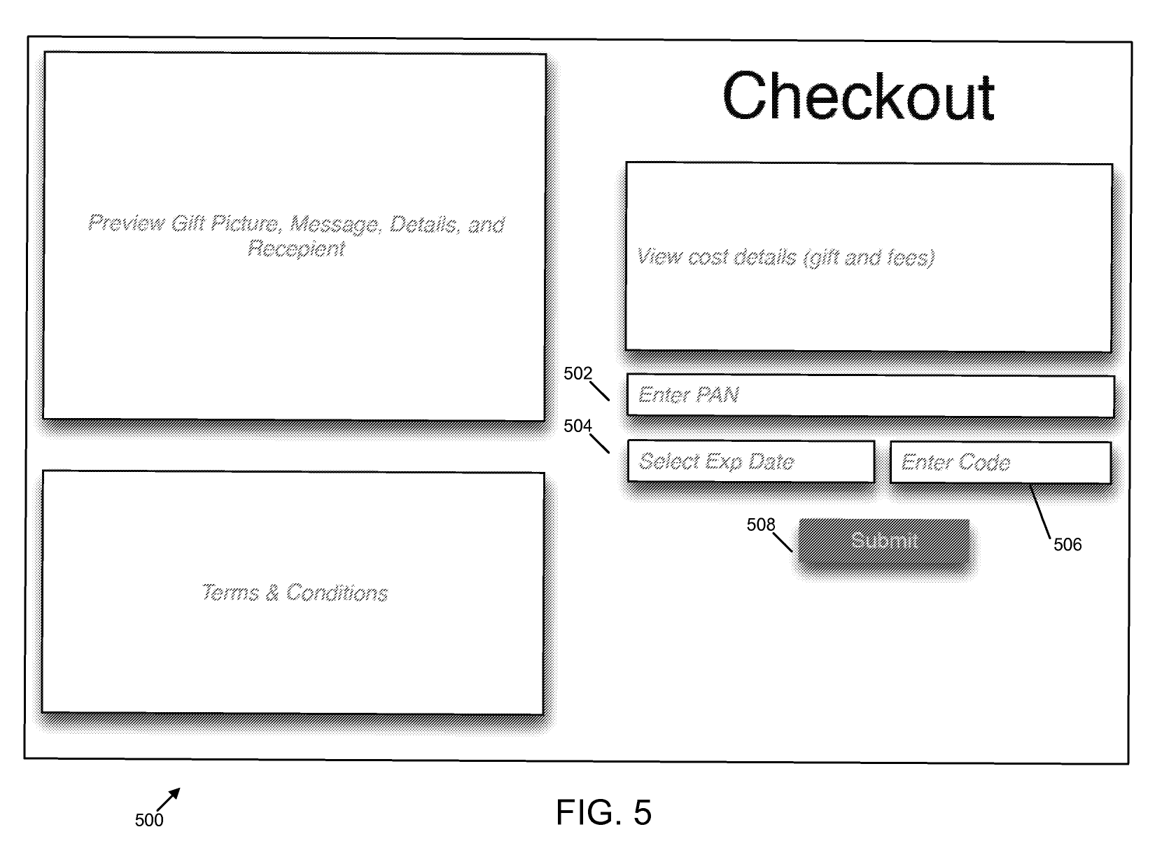

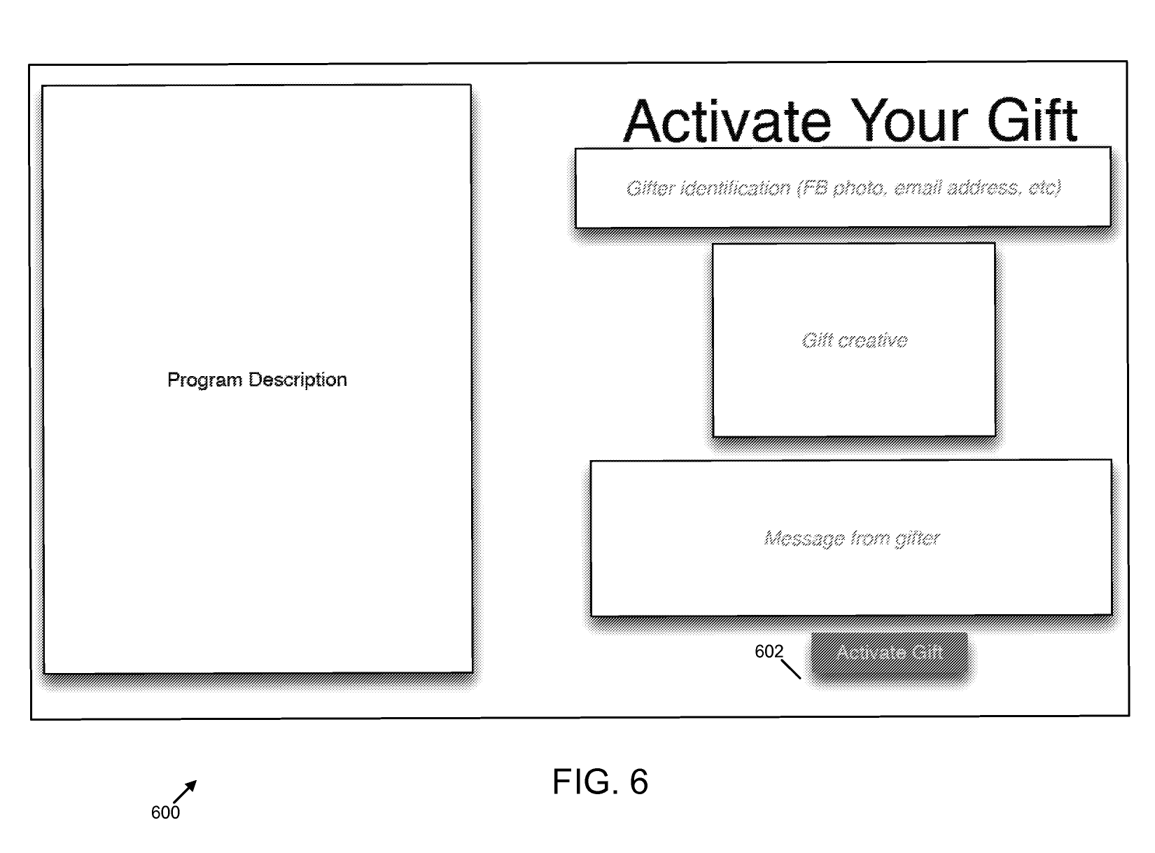

In the embodiment illustrated in FIG. 1, the incentive management system 122 is configured to implement the user interfaces 108, 110, and 112 in conjunction with the computer systems 114, 116, and 118 via the network 120. For example, in some embodiments illustrated by FIG. 1, the interfaces 108, 110, and 112 are browser-based user interfaces served by the incentive management system 122. In other embodiments, the user interfaces 108, 110, and 112 are implemented as components within social media systems, such as the FACEBOOK social networking system available online from Facebook Inc. of Menlo Park, Calif., the TWITTER social networking and microblogging service available online from Twitter, Inc. of San Francisco, Calif., LINKEDIN social networking system available online from Linkedin Corporation of Mountain View, Calif., etc. or other communication interfaces such as display networks, blog-sphere, email list servers, etc. In still other embodiments, the interfaces 108, 110, and 112 are specialized client programs that execute outside of a browser environment, such as an application program executing on a mobile device. The user interfaces 108, 110, and 112 may be implemented using a variety of technologies and may include sundry elements (e.g., screens, windows, buttons, boxes, etc) arranged according to various user interface metaphors, as desired. As described further below, FIGS. 4 and 5 further illustrate some of the elements used to implement the purchaser user interface 108 and FIG. 6 further illustrates some of the elements used to implement the recipient user interface 110.

In some embodiments, the incentive management system 122 exchanges information with the social media systems 124. Examples of the social media systems 124 include FACEBOOK, TWITTER, LINKEDIN, the FOURSQUARE location based social network system available online from Foursquare Labs, Inc. of New York, N.Y., the GOOGLE+ social networking system available online from Google Inc. of Mountain View, Calif., and may include mailing lists, email systems, texting systems, telephone systems, and the like. The information exchanged between the incentive management system 122 and the social media systems 124 may include data descriptive of identified users of the incentive management system 122, such as indications of the validity of logon credentials, account information, and profile information, as well as data descriptive of the social network to which the identified users belong, such as groups, friends, followers, other users commented on by the identified users, or other users who authored comments associated with the identified users. As described further below, in some embodiments, the incentive management system 122 is configured to store and utilize this information to identify potential purchasers and recipients of incentives.

In other embodiments, the incentive management system 122 exchanges information with the financial management systems 126. These financial management systems 126 may include financial systems, payment networks, rewards or points accounts, mobile payment accounts, and issuing banks and others. Examples of the financial systems include the FIRST DATA system available from First Data Corporation of Atlanta Ga., the CHASE PAYMENTTECH system available from Paymentech, LLC of Dallas Tex., the PAYPAL system available online from PayPal, Inc. of San Jose, Calif., the YODLEE system available from Yodlee, Inc. of Redwood City, Calif., and the like. Examples of payment networks 126 include VISANET available from Visa, Inc. of San Francisco Calif., BANKNET available from MasterCard International Incorporated of Purchase, New York, and the like. Examples of issuing banks include Citibank N.A. of New York, N.Y., Capital One Financial Corporation of Richmond, Va., JPMorgan Chase & Co. of New York, N.Y., Bank of America Corporation of Charlotte, N.C., and the like.

The information exchanged between the incentive management system 122 and the financial management systems 126 may include data descriptive methods of payment utilized by identified, e.g. registered users (purchasers and recipients), data descriptive of transactions conducted by the identified users, and data descriptive of incentives redeemed by the identified users. In some embodiments, the incentive management system 122 detects transactions conducted using identified methods of payment and effects redemptions of incentives by exchanging information with the financial management systems 126.

Information may flow between the components illustrated in FIG. 1, or any of the elements, components and subsystems disclosed herein, using a variety of techniques. Such techniques include, for example, passing the information over a network using standard protocols, such as TCP/IP, HTTP, HTTPS, SMTP or SMS passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

### Incentive Management System

The incentive management system 122 may be configured according to a variety of architectures. FIG. 2 illustrates one such architecture in which the physical and logical components of the incentive management system 122 are configured as a distributed system. The architecture illustrated in FIG. 2 is provided for exemplary purposes only and embodiments disclosed herein are not limited to the architecture shown in FIG. 2. For example, in some of the embodiments, the physical components described below may be virtualized.

As depicted in FIG. 2, the incentive management system 122 includes five primary physical elements: a load balancer 202, a web server 204, an application server 206, a data storage server 208 and a network 210. Each of these physical elements may include one or more computer systems as discussed below with reference to FIG. 3. The load balancer 202 provides load-balancing services to the other components of incentive management system 122. The web server 204, which may alternately be a communication or interface server (for example an email, mobile, txt gateways, POS, etc.), may serve content using any suitable standard or protocol including, among others, HTTP, HTML, DHTML, XML and PHP. The data storage server 208 may provide data storage and retrieval services by using a database management system, such as MYSQL or ORACLE, or by using some other data storage methodology, such as a file system supported by the operating system executing on the data storage server 208, as would be known by those of skill in the art. Like the network 120 described above with reference to FIG. 1, the network 210 may include any communication network through which member computer systems may exchange data.

In the embodiment illustrated in FIG. 2, the web server 204 includes five logical elements, a purchaser interface 212, a recipient interface 214, a merchant interface 216, a financial systems interface 218, and a social media interface 220. The application server 206 includes two logical elements: an incentive engine 226 and a data access engine 228. The data storage server 208 includes two logical elements: an incentive information data store 222 and a user information data store 224.

In the embodiment illustrated in FIG. 2, the web server 204 implements the purchaser interface 212, the recipient interface 214, and the merchant interface 216. Each of these interfaces may exchange information with a variety of external entities, such as users or external systems. For example, according to one embodiment, the purchaser interface 212 is configured to serve a browser-based user interface to the purchaser 102 that is rendered as the purchaser user interface 108 by a web browser executing on the computer system 114. The recipient interface 214 and the merchant interface 216 may also be configured to serve browser-based user interfaces to the recipient 104 and the merchant 106 that are rendered as the recipient user interface 110 and the merchant user interface 112 by web browsers executing on the computer systems 116 and 118. In some embodiments, the merchant interface 216 is configured to implement a merchant system interface that exchanges information with one or more external systems controlled by the merchant 106. The information exchanged via the merchant system interface may be descriptive of products and services offered by the merchant, for example, through a stock-keeping unit (SKU) code or a radio-frequency identification (RFID) code, that are subject to one or more incentives.

According to one embodiment, the purchaser interface 212 is configured to provide information descriptive of incentives available for purchase within the incentive management system 122. In this embodiment, the purchaser interface 212 exchanges incentive information with the purchaser user interface 108. The incentive information exchanged between the purchaser interface 212 and the purchaser user interface 108 may include search requests and search responses. Search requests specify the characteristics of incentives targeted by the request. Search responses may include information descriptive of incentives having the characteristics specified in a search request corresponding to the search response. Responsive to receiving a search request, the purchaser interface 212 may retrieve, via the data access engine 228, information descriptive of the incentives having the characteristics specified in the search criteria and may provide this information to the purchaser user interface 108 for further processing. For example, the purchaser user interface 108 may further process the information by sorting and ranking the incentives in order accordance to relevance.

The incentive information exchanged between the purchaser interface 212 and the purchaser user interface 108 may also include purchaser history in order to present incentives in a ranked order based upon past incentive purchases made by the purchaser. In this embodiment, information of past incentives purchased is stored in the data storage server 208 and is retrieved by the purchaser interface 212 and exchanged with the purchaser user interface 108. The past purchased incentive information may include information descriptive of a variety of incentive characteristics. Examples of these characteristics may include a particular merchant or type of merchant, merchant location, a purchased product category, a purchased product, a purchased incentive amount or a combination of parameters.

According to another embodiment, the information exchanged between the purchaser interface 212 and the purchaser user interface 108 may also include purchaser history in order to group purchasers into different purchaser groups. Depending upon the criteria set for the purchaser group, different incentives may be available to the group members that are not available for other purchasers. In this embodiment, to be included in the group a purchaser would have to meet a particular set of criteria. These criteria may include things such as the total amount of incentives purchased, for example total monetary value or total number of incentives gifted during a certain time period, particular level of incentives purchased through a particular merchant or for a particular type of product, other details of purchaser history, or other established criteria. Specific incentives can be made available to the members of the purchaser group. These incentives may be in the form of incentives not otherwise available, or as rewards for achieving a certain level of purchases or for an amount of purchase made during a certain time period, that can be redeemed by the purchaser, recipient or other third party, for example a charity. The criteria for becoming a member of the purchaser group (for example a silver, gold or platinum group member) may be promoted to the purchasers, as described in further detail below, as a way to increase participation in gifting incentives.

In at least one embodiment, merchants, such as the merchant 106, who use the incentive management system, define the incentives available for purchase within the incentive management system 122. The incentives may additionally contain conditions as to how to qualify to redeem the incentive, or other conditions that need to be fulfilled as defined by the merchants. For example, one condition may be that the incentive can be redeemed only at certain locations, only during certain days of the week, for certain dollar amounts, only for certain products, or any combination of conditions, such conditions not being limited to those disclosed herein, but any condition or combination of conditions issued by the merchant. The conditions of the incentive are typically provided to the purchaser through the purchaser user interface 108 at or before the purchaser accepts the incentive.

According to another embodiment, the purchaser interface 212 is configured to receive one or more requests to purchase incentives from the purchaser user interface 108. In this embodiment, the purchase requests may include information descriptive of a variety of incentive characteristics. Examples of these characteristics include one or more recipients of the incentive, a method of payment used to purchase the incentive, a requested monetary value for the incentive, a requested link activation period, and a requested redemption period. In some embodiments, purchase request information may further include a requested merchant, a requested merchant location, a requested product category, a requested product, or a combination of parameters. One example of a screen presented within the purchaser user interface 108 and that is configured to generate a purchase request is described further below with reference to FIG. 4.

In some embodiments, the purchaser interface 212 is configured to respond to any received purchase request by attempting to validate the purchase requested therein. In these embodiments, the purchaser interface 212 validates a purchase request by identifying, within the incentive information data store 222, at least one incentive having the characteristics specified in the purchase request. In one embodiment, the purchaser interface 212 performs this identification via the data access engine 288. Responsive to validating the purchase request, the purchaser interface 212 instructs the purchaser user interface 108 to display a screen, such as the checkout screen 500 described below with reference to FIG. 5, through which the purchaser can complete the purchase request.

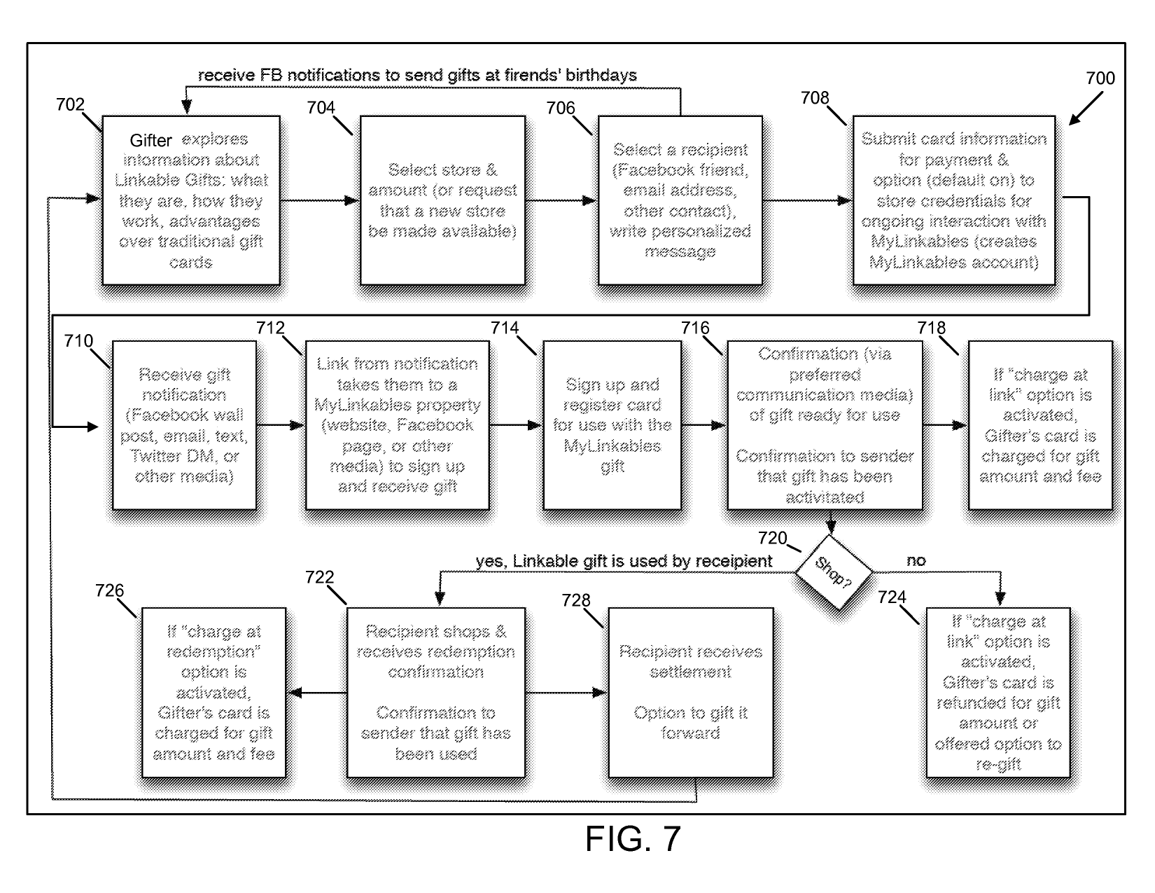

In other embodiments, the purchaser interface 212 is configured to complete a purchase request in response to receiving a request to do so from the purchaser user interface 108. Exemplary processes executed by the purchaser interface to complete a purchase request are described further below with reference to FIG. 7.

In another embodiment, the purchaser interface 212 is configured to receive requests to contribute to incentives purchased by other members of a group of purchasers who wish to combine funds. In this embodiment, these requests are received from the purchaser user interface 108 and may specify one or more characteristics of previously purchased incentives to which the purchaser 102 wishes to contribute funds. After matching the request to the previously purchased incentives, the purchaser interface 212 transmits a request to the financial systems interface 218 to debit the purchaser's method of payment by an amount equal to the contribution amount plus any applicable transaction fee and to credit an intermediate account holding the funds for the purchased incentive by an amount equal to the contribution amount. In this embodiment, the purchaser interface 212 may further store, via the data access engine 228, an association between the purchaser 102 and the previously purchased incentive in the incentive information data store 222. This association may be subsequently used by the incentive engine to identify the purchaser 102 as having contributed to the redemption amount associated with the incentive. Thus, in these embodiments, groups of purchasers may contribute to a single incentive, thereby allowing groups of purchasers to create a combined pool of monetary value for one or more recipients.

In another embodiment, the purchaser interface 212 is configured to receive requests to create purchaser groups from the purchaser user interface 108. These requests may specify a group of persons wishing to purchase or contribute to an incentive for one or more common recipients. Responsive to receiving this request, the purchaser interface 212 creates and stores, via the data access engine 228, information descriptive of the group and its members. As members of the group utilize the purchaser interface 212 to purchase or contribute to an incentive, the purchaser interface 212 transmits a request to the financial systems interface 218 to debit the purchaser's method of payment by an amount equal to the contribution amount plus any applicable transaction fee and to credit an intermediate account holding the funds for the purchased incentive by an amount equal to the contribution amount. The purchaser interface 212, in conjunction with the data access engine 228, may also record data that tracks the contributions of each member. In some embodiments, the purchaser interface 212 may provide the purchaser user interface 108 with information describing the amount contributed to the incentive by each member, thereby increasing the likelihood that individual members will contribute to the incentive.

In all of the embodiments, the purchaser registers an account through the user interface 212 of the incentive management system 122 which may be stored in data storage server 208, i.e. in the user information data store 224. The account may be used to track and display incentives to the potential purchaser, for example based on past purchase history, income, gender, or other demographic information. The information may be stored so that other incentives can be purchased without re-entering stored information. Incentives can be presented to the purchaser in a variety of ways including, but not limited to, mobile, online and offline advertising, using any available technology and may be available only to certain groups of purchasers. As described above, incentives may be subject to terms that place conditions of redemption of the incentives. Examples of conditions that terms place on incentives include requiring redemption with a defined time period, requiring redemption at a defined merchant location, requiring redemption of a minimum purchase amount, requiring redemption for a product or service that falls within a defined category, etc. Alternatively, the incentives can be subject to terms and conditions at purchase instead of redemption. For example, the purchase may have to be a certain amount or made by a purchaser who is part of a merchant reward program and who has attained a certain reward level, for example silver, gold, platinum to be eligible to purchase the reward.

According to some embodiments, the recipient interface 214 is configured to receive and exchange recipient information 104 (e.g., name, address, methods of payment utilized by the recipient, etc.) descriptive of a profile of the recipient that may be provided by the recipient through the recipient user interface 110 as described below. For example, the recipient may register an account through the recipient interface 214 which may stored in data storage server 208, or the purchaser may provide initial recipient information in order to identify the recipient, such as through the social media systems 124. Information descriptive of the methods of payment included in the profile information may include information descriptive of a debit card account or a credit card account, checking account, etc. This is by way of example only, and it should be understood that a variety of other types of payment methods can be utilized including, but not limited to PayPal and eWise accounts, mobile payment accounts, virtual money accounts, and rewards or points accounts. If a credit and/or debit card is utilized it can be either an open loop or closed loop card. In addition, instead of using a credit/debit card having account information presented in a magnetic stripe on the back of the card, payment and account details can be presented to merchants through a variety of other media, methods, and devices including, but not limited to, smart phones, retinal/finger scans, RFID tags, and any other technology implemented to process payments. In at least one embodiment, the information descriptive of the methods of payment also specifies a default method of payment to be linked to incentives in the absence of an indication to link a different method of payment.

In some embodiments, the recipient interface 214 exchanges the recipient information with the recipient user interface 110. In response to receiving the recipient information, the recipient interface 214 stores, via the data access engine 228, the recipient information in the user information data store 224. By storing the recipient information, other incentives from the same or other purchasers can be easily linked to the recipient's default method of payment without the recipient having to re-enter the information.

In another embodiment, the recipient interface 214 is configured to exchange information that activates one or more incentives purchased for the recipient 104. This activation information may include information identifying a method of payment to link with the incentive. In this embodiment, the recipient interface 214 exchanges this activation information with the recipient user interface 110. FIG. 6, which is described further below, illustrates one example of a screen presented in the recipient user interface 110 to receive activation information. In response to receiving the activation information, the recipient interface 214 stores, via the data access engine 228, the activation information in the incentive information data store 222.

According to one embodiment, the merchant interface 216 is configured to provide information descriptive of purchased incentives associated with the merchant 106. In this embodiment, the merchant interface 216 receives requests for incentive information from the merchant user interface 112. These requests may include search criteria that indicate the characteristics of incentives targeted by the request. Responsive to receiving these requests, the merchant interface 216 may retrieve, via the data access engine 228, information descriptive of the purchased incentives that match the search criteria and may provide this information to the merchant user interface 112 for further processing.

In another embodiment, the merchant interface 216 is configured to receive requests to establish, or contribute to, incentives from the merchant user interface 112. These contribution requests may specify one or more characteristics of incentives to which the merchant 106 wishes to contribute funds and a monetary value to be contributed to the incentives. For example, a contribution request may specify a contribution amount of $10 for all incentives having a redemption amount of $50 or more, a redemption period of less than 6 months, a targeted recipient who resides in the zip code 02210, and a restricted product or service category of home improvement. The request may also target a certain demographic of purchasers. Responsive to receiving a request, the merchant interface 216 stores, via the data access engine 228, information in the incentive information data store 222 that indicates the one or more characteristics of the incentives targeted for contribution, the contribution amount and the party to whom the contribution is to be attributed (e.g., the purchaser 102 or the merchant 106). As described further below, when redeeming incentives, the incentive engine 226 analyzes whether the incentive has been targeted by a contribution request and processes the redemption appropriately.

In some embodiments, the merchant interface 216 is configured to provide one or more bidding screens to a plurality of merchants via the merchant user interface 112. In these embodiments, a bidding screen receives bids in the form of requests to contribute to incentives and displays groups of contribution requests having similar incentive characteristics. In at least one embodiment, the bidding screen displays the contribution requests of each group ranked according to contribution amount. In this embodiment, the incentive engine 226, which is described further below, is configured to associate merchants with higher contribution amounts with purchased incentives when the purchased incentives are linked to the recipient's method of payment.

In other embodiments, bidding screens are configured to receive a set of bidding criteria and to provide the bidding criteria to the merchant interface 216. In these embodiments, the merchant interface 216 includes a bidding engine that places bids (e.g., issues contribution requests) on behalf of merchants in accord with the bidding criteria received by the merchant interface 216. The bidding criteria may specify that the bidding engine place one or more bids on one or more identified incentives. The bidding criteria may specify that the bidding engine identify incentives upon which to place bids based on any individual characteristic of incentives, or for a particular group of purchasers, as described herein or any combination thereof.

According to one embodiment, the merchant interface 216 is configured to provide information descriptive of purchasers who utilize the incentive management system 122. In this embodiment, the merchant interface 216 exchanges purchaser information with the merchant user interface 108. The purchaser information exchanged between the merchant interface 216 and the merchant user interface 108 may include search requests and search responses. Search requests specify the characteristics of purchasers targeted by the request. Search responses may include information descriptive of purchases having the characteristics specified in a search request corresponding to the search response. Responsive to receiving a search request, the merchant interface 216 may retrieve, via the data access engine 228, information descriptive of the purchasers having the characteristics specified in the search criteria and may provide this information to the merchant user interface 108 for further processing.

Continuing with the embodiment illustrated in FIG. 2, the web server 204 also implements the financial systems interface 218 and the social media interface 220. Both of these interfaces may exchange information with a variety of external entities, such as users or external systems. For example, according to one embodiment, the financial systems interface 218 is configured to exchange information with one or more external financial systems. The information exchanged via the financial systems interface 218 may be descriptive of financial transactions that reflect incentives initiated by the purchaser 102 or redeemed by the recipient 104. More particularly, in at least one embodiment, the information exchanged via the financial systems interface 218 may debit accounts held by the purchaser 102, may credit accounts held by the recipient, verify a method of payment entered by a purchaser or recipient, or may be descriptive of merchant offerings purchased by the recipient 104.

According to another embodiment, the social media interface 220 exchanges information with one or more social media websites using a series of application program interface, or “API” calls specific to each social media website. The information exchanged via the social media interface 220 may include information descriptive of the user (e.g., validity of logon credentials) and information descriptive of the user's social network (e.g., other users associated with the user on each social media website). In at least one embodiment, the information exchanged via the social media interface 220 is used to identify potential recipients of incentives. In another embodiment, this information exchanged via the social media interface 220 is used to communicate information descriptive of incentives purchased, linked, and redeemed to users of the social media system 124.

Referring again to FIG. 2, the application server 206 may provide computing resources to the incentive engine 226 and the data access engine 228. The incentive engine 226 is configured to perform a variety of processes that facilitate the creation, storage, tracking, and redemption of purchase incentives. Exemplary processes performed by the incentive engine 226 are described further below with reference to FIG. 7. The data access engine 228 provides an application program interface (“API”) through which other components, such as the purchaser interface 212, the recipient interface 214, the merchant interface 216, the financial systems interface 218, the social media interface 220, and the incentive engine 226, exchange information with the incentive information data store 222 and the user information data store 224. In the embodiment shown in FIG. 2, both the incentive engine 226 and the data access engine 228 exchange information with the purchaser interface 212, the recipient interface 214, the merchant interface 216, the financial systems interface 218, the social media interface 220, the incentive information data store 222, and the user information data store 224.

In the embodiment illustrated in FIG. 2, the data storage server 208 provides computing resources to the incentive information data store 222 and the user information data store 224. The incentive information data store 222 stores a variety of information related to incentives. Examples of this information include characteristics of configured incentives that are available for purchase, information descriptive of purchased instances of incentives, and historical information descriptive of the history of incentive purchases and redemptions managed by the incentive management system 122, and may include others as desired. The user information data store 224 stores information descriptive of the purchasers, recipients, and merchants who use the incentive management system 122. Examples of the information stored in the user information data store 224 include logon credentials and profile information. The data stores 222 and 224 may take the form of any logical construction capable of storing information on a computer readable medium including flat files, indexed files, hierarchical databases, relational databases or object oriented databases or others as would be known to those of skill in the art. The data may be modeled using unique and foreign key relationships and indexes. The unique and foreign key relationships and indexes may be established between the various fields and tables to ensure both data integrity and data interchange performance.

Various embodiments may implement the components described above using a variety of hardware components, software components and combinations of hardware and software components. Thus embodiments disclosed herein are not limited to the particular configuration illustrated in FIGS. 1 and 2 and may utilize alternative or additional components configured to perform the processes and functions described herein.

### Computer System

As discussed above with regard to FIGS. 1 and 2, various aspects and functions described herein may be implemented as specialized hardware or software components executing in one or more computer systems. There are many examples of computer systems that are currently in use and the description provided herein is not intended to be limiting. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one more computer systems that exchange information. More specifically, the distributed computer system 300 includes computer systems 302, 304 and 306. As shown, the computer systems 302, 304 and 306 are interconnected by, and may exchange data through, a communication network 308. The network 308 may include any communication network through which computer systems may exchange data. To exchange data using the network 308, the computer systems 302, 304 and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 302, 304 and 306 may transmit data via the network 308 using a variety of security measures including, for example, TLS, SSL or VPN. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions and processes disclosed herein, the processor 310 performs a series of instructions that result in manipulated data. The processor 310 may be any type of processor, multiprocessor or controller. Some exemplary processors include commercially available processors such as an Intel Xeon, Itanium, Core, Celeron, or Pentium processor, an AMD Opteron processor, an Apple A4 or A5 processor, a Sun UltraSPARC or IBM Power5+ processor and an IBM mainframe chip. The processor 310 is connected to other system components, including one or more memory devices 312, by the interconnection element 314.

The memory 312 stores programs and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device as would be known to those of skill in the art. Various examples may organize the memory 312 into particularized and, in some cases, unique structures to perform the functions disclosed herein. These data structures may be sized and organized to store values for particular data and types of data.

Components of the computer system 302 may be coupled by an interconnection element such as the interconnection element 314. The interconnection element 314 may include one or more physical busses, for example, busses between components that are integrated within a same machine, but may include any communication coupling between system elements including specialized or standard computing bus technologies such as IDE, SCSI, PCI and InfiniBand. The interconnection element 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, which allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista, Windows 7 or Windows 8 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### User Interface Screens

FIGS. 4-6 illustrate three interface screens provided according to various embodiments. It is to be appreciated that many other interface screens may be provided, and embodiments described herein are not limited to a particular interface screen or set of screens. FIG. 4 illustrates a purchase screen 400. As shown in FIG. 4, the purchase screen 400 may include a combination of the following: a program description area, a merchant selection box 404 used to chose a particular merchant, a redemption amount box 406 for specifying the amount of the incentive, a redemption period box 408 to set a desired time period in which to redeem the incentive, a communication channel selection box 410 to indicate the preferred method of communicating with the purchaser, a recipient selection box 412 for indicating the recipient of the incentive, an aesthetic selection box 414 to choose the look presented, a message box 416 for a message from the purchaser to the recipient, and a check out button 418 to process the purchase of the incentive. Each of the boxes 404-416 provides actionable screen areas through which the purchaser user interface 108 may receive information from the purchaser 102. The checkout button 418, when actuated, causes the purchaser user interface 108 to validate the information entered with the boxes 404-416 and sends a request to the purchaser interface 212 to provide the check out screen 500.

FIG. 5 illustrates the checkout screen 500. As shown in FIG. 5, the checkout screen 500 includes several areas that display a variety of information such as a preview aesthetic, message, details, and recipient information; terms and conditions associated with the incentive; and cost details (redemption amount and transaction fees, if any) associated with the incentive. In addition, the checkout screen 500 includes a primary account number (“PAN”) box 502, a date box 504 to select the expiration date of the redemption period, a promotion code box 506, and a submit button 508. Each of the boxes 502-506 provides actionable screen areas through which the purchaser user interface 108 may receive information from the purchaser 102. The submit button 508, when actuated, sends a request to the purchaser interface 212 to complete the purchase of the incentive.

FIG. 6 illustrates the activation screen 600. As shown in FIG. 6, the activation screen 600 includes several areas that display a variety of information such as a program description, purchaser (“gifter”) identification information, an incentive aesthetic, and a message from the gifter. In addition, the activation screen 600 includes an activate incentive button 602. The activate incentive button 602, when actuated, sends a request to the recipient interface 214 to link the incentive to the method of payment associated with the recipient in the user information data store 224.

### Incentive Management Processes

As described above with reference to FIG. 2, some embodiments perform processes that manage incentives using a distributed system, such as the incentive management system 122. One example of such an incentive management process is illustrated in FIG. 7. According to this example, the incentive management process 700 includes several acts, which are described further below.

In act 702, the incentive management system provides information regarding potential incentives to a purchaser, such as the purchaser 102 described above with reference to FIG. 1, via a purchaser user interface, such as the purchaser user interface 108 described above with reference to FIG. 1. In acts 704 and 706, the incentive management system receives, via a purchaser interface such as the purchaser interface 212 described above with reference to FIG. 2, information requesting purchase of an incentive. In some embodiments, this incentive request information is received by the purchaser user interface via an incentive purchase screen, such as the incentive purchase screen described above with reference to FIG. 4. In these embodiments, the purchaser indicates a variety of characteristics desired for the incentive via the incentive purchase screen. Examples of these characteristics include any combination of the following: a merchant, a merchant location, a redemption amount, a redemption period, a preferred communication channel, one or more recipients, an aesthetic to display in notifications regarding the incentive, and a message. In some embodiments, the purchaser interface restricts values of the characteristics available for selection to a predefined set.

In other embodiments, the purchaser interface provides screen elements via the purchaser user interface that receive newly requested characteristics or newly requested values for characteristics. For example, the purchaser interface may receive requests for a new recipient, a new merchant or merchant location via these screen elements. Within the acts 704 and 706, the incentive request information received from the purchaser by the purchaser user interface is transmitted to the purchaser interface which, in turn, transmits a request to store this incentive request information along with information identifying the request and associating the request with the purchaser to a data access engine, such as the data access engine 228 described above with reference to FIG. 2. The data access engine 228 stores the incentive request information in an incentive information data store, such as the incentive information data store 222 described above with reference to FIG. 2.

According to at least one embodiment, within the act 706 the purchaser interface stores, via the data access engine, associations between the purchaser and the one or more recipients within a user information data store, such as the user information data store 224 described above with reference to FIG. 2. In this embodiment, the social media interface may later issue notifications to the purchaser regarding the recipients, such as reminders that the recipient's birthday, anniversary, or other auspicious occasion is approaching.

In act 708, the purchaser interface receives a request to complete an incentive purchase from the purchaser user interface. Responsive to receiving this request, the purchaser interface instructs the purchaser user interface to provide a checkout screen, such as the checkout screen 500 described above with reference to FIG. 5. According to this example, the purchaser user interface receives a variety of checkout information via the checkout screen. This information may include a PAN, expiration date of the redemption period, and information associated with a credit card or a debit card used to fund the incentive purchase, or other information. Responsive to receiving this checkout information, the purchaser interface transmits a request to store the checkout information to the data access engine that, in turn, stores the checkout information in the incentive information data store.

In some embodiments, within the act 708, an incentive engine executing within the incentive management system, such as the incentive engine 226 described above with reference to FIG. 2, determines whether the purchaser's method of payment is to be charged responsive to purchase of the incentive. In some embodiments, the incentive engine makes this determination by retrieving and inspecting, via the data access engine, information stored within the incentive information data store that is descriptive of the payment options associated with the incentive. If the payment options indicate that the purchaser is to be charged in response to purchase of the incentive, the incentive engine transmits a request to a financial systems interface, such as the financial systems interface 218 described above with reference to FIG. 2, to debit the purchaser's method of payment by an amount equal to the redemption amount plus any applicable transaction fee and to credit an intermediate account associated with the incentive by an amount equal to the redemption amount. Should a merchant have contributed any funds, these funds will be accounted for by the incentive engine as described further below with regard to act 718. In some embodiments, the incentive engine makes this determination in response to a notification received from the purchaser interface that indicates new incentive request information and new checkout information is available in the incentive information data store. In other embodiments, the incentive engine makes this determination as part of a scan of the incentive information data store that the incentive engine executes in conjunction with the data access engine according to a periodic schedule. In some embodiments, the periodic schedule is a configurable parameter of the incentive management system.

In the act 710, a social media interface, such as the social media interface 220 described above with reference to FIG. 2, transmits a notification of the availability of the incentive to accounts associated with a recipient of the incentive, such as the recipient 104 described above with reference to FIG. 1. These accounts may include email accounts, FACEBOOK accounts, TWITTER accounts, and the like. The notifications may take the form of any communication supported by the applicable account, such as FACEBOOK wall posts, TWITTER tweets, text messages, and the like. In some embodiments, the notifications may include links to the incentive management system. In addition, in some embodiments, the social media interface transmits a confirmatory message to the purchaser of the incentive that indicates the recipient has been notified of the availability of the incentive.

In the act 712, a recipient interface, such as the recipient interface 214 described above with reference to FIG. 2, receives a request to provide an incentive activation screen, such as the incentive activation screen 600 described above with reference to FIG. 6, in response to the recipient actuating the link included in the notification. Responsive to receiving this request, the recipient interface instructs a recipient user interface, such as the recipient user interface 110 described above with reference to FIG. 1, to present the incentive activation screen. Responsive to receiving an indication that the recipient wishes to activate the incentive (e.g., the activate incentive button 602 being actuated), the recipient interface determines, by exchanging information with data access engine, whether the recipient has account information stored within the user information data store.

If not, in act 714, the recipient interface gathers the information necessary to create an account via the recipient user interface. This information may include profile information such as the name, address, and method of payment information for the recipient. Responsive to receiving the account information, the recipient interface transmits a request to store the profile information to the data access engine, which, in turn, stores the profile information in the user information data store. Where the recipient has profile information stored within the user information data store, the recipient interface transmits a request to the incentive engine to link the incentive to a method of payment associated with the recipient in the user information data store. In response to receiving this request, the incentive engine records a link between the incentive and the method of payment associated with the recipient.

In act 716, the incentive engine transmits a request to the social media interface to send notifications to the purchaser and the recipient indicating that incentive has been activated. Responsive to receipt of this notification request, the social media interface retrieves information descriptive of preferred communication channels associated with the purchaser and the recipient from the user information data store via the data access engine and sends the notifications according to the preferred communication channels.

In act 718, the incentive engine determines whether the purchaser's method of payment is to be charged responsive to linking of the incentive to the recipient's method of payment. In some embodiments, the incentive engine makes this determination by retrieving and inspecting, via the data access engine, information stored within the incentive information data store that is descriptive of the payment options associated with the incentive. Where payment options indicate that the purchaser is to be charged in response to linking of the incentive to a method of payment of the recipient, the incentive engine transmits a request to the financial systems interface to debit the purchaser's method of payment by an amount equal to the redemption amount plus any applicable transaction fee and to credit an intermediate account associated with the incentive by an amount equal to the redemption amount. Then the incentive engine transmits a request to the social media interface to send notifications to the purchaser and the recipient indicating that incentive has been funded. Responsive to receipt of this notification request, the social media interface retrieves information descriptive of preferred communication channels associated with the purchaser and the recipient from the user information data store via the data access engine and sends the notifications according to the preferred communication channels.

Next, the incentive engine retrieves, via the data access engine, any additional contribution amounts provided by merchants that are associated with the incentive and transmits a request to the financial systems interface to debit each contributor's account by an amount equal to the contribution amount associated with each contributor plus any applicable transaction fee and to credit an intermediate account associated with the incentive by an amount equal to each contribution amount. Then the incentive engine transmits a request to the social media interface to send notifications to the merchant and the recipient indicating that the incentive has received contributions. Responsive to receipt of this notification request, the social media interface retrieves information descriptive of preferred communication channels associated with the contributing merchants from the user information data store via the data access engine and sends the notifications according to the preferred communication channels. In this way, the incentive engine processes funds contributed by merchants to a purchased incentive.

In act 720, the incentive engine receives, via the financial systems interface, transaction activity associated the recipient's linked method of payment. If this activity indicates that the recipient has redeemed the incentive, the incentive engine executes act 722. Otherwise, the incentive engine executes act 724.

In act 722, the incentive engine transmits a request to the social media interface to send notifications to the purchaser, the recipient, and any contributing merchants indicating that incentive has been redeemed. Responsive to receipt of this notification request, the social media interface retrieves information descriptive of preferred communication channels associated with the purchaser, the recipient, and any contributing merchants from the user information data store via the data access engine and sends the notifications according to the preferred communication channels.

In act 726, the incentive engine determines whether the purchaser's method of payment is to be charged responsive to redemption of the incentive. In some embodiments, the incentive engine makes this determination by retrieving and inspecting, via the data access engine, information stored within the incentive information data store that is descriptive of the payment options associated with the incentive. If payment options indicate that the purchaser is to be charged in response to redemption of the incentive, the incentive engine transmits a request to the financial systems interface to debit the purchaser's method of payment by an amount equal to the redemption amount plus any applicable transaction fee and to credit an intermediate account associated with the incentive by an amount equal to the redemption amount. Then the incentive engine transmits a request to the social media interface to send notifications to the purchaser and the recipient indicating that incentive has been funded. Responsive to receipt of this notification request, the social media interface retrieves information descriptive of preferred communication channels associated with the purchaser and the recipient from the user information data store via the data access engine and sends the notifications according to the preferred communication channels.

Next, the incentive engine retrieves, via the data access engine, any additional contribution amounts provided by merchants that are associated with the incentive and transmits a request to the financial systems interface to debit each contributor's account by an amount equal to the contribution amount associated with each contributor plus any applicable transaction fee and to credit an intermediate account associated with the incentive by an amount equal to each contribution amount. Then the incentive engine transmits a request to the social media interface to send notifications to the merchant and the recipient indicating that incentive has been received contributions. Responsive to receipt of this notification request, the social media interface retrieves information descriptive of preferred communication channels associated with the contributing merchants from the user information data store via the data access engine and sends the notifications according to the preferred communication channels. In this way, the incentive engine processes funds contribute by merchants to a purchased incentive.

In act 728, the incentive engine retrieves, via the data access engine, the total redemption amount associated with the redeemed incentive and transmits a request to the financial systems interface to debit the intermediate account associated with the incentive by an amount equal to the total redemption amount and to credit an account associated with the recipient, such as the method of payment linked to the incentive, by an amount equal to the total redemption amount. As described above, in some instances, the total redemption amount may include a plurality of discrete redemption amounts contributed by various parties. In some embodiments, the incentive engine also transmits a request to the social media interface to send a notification to the recipient indicating that the incentive has been redeemed and that the recipient has the option of forwarding the credit or the incentive to another user. The notification may further include a link to the purchaser interface. Next, the incentive management system terminates the process 700.

In act 724, the incentive engine determines whether the redemption period associated the incentive has expired. In some embodiments, the incentive engine makes this determination by retrieving and inspecting, via the data access engine, information stored within the incentive information data store that is descriptive of the redemption period associated with the incentive. If the redemption period has expired, the incentive engine determines whether the incentive has already been funded by retrieving and inspecting, via the data access engine, information stored within the incentive information data store that is descriptive of payment options associated with the incentive. If the payment options indicate that the purchaser was charged in response to purchasing the incentive or in response to linking of the incentive to the recipient's method of payment, the incentive engine transmits a request to the financial systems interface to debit the intermediate account associated with the incentive by an amount equal to the redemption amount less any portion of the redemption amount redeemed prior to the expiration of the incentive and to credit an account associated with the purchaser, such as the method of payment used to fund the incentive, by an amount equal to the redemption amount less any portion of the redemption amount redeemed prior to the expiration of the incentive. The credit may also be issued to a third party chosen by the purchaser, for example a charity. In situations where the financial systems interface is unable to credit the method of payment used to fund the incentive (e.g. where the method of payment has been closed), the financial systems interface transmits a request to the social media interface to send a notification to the purchaser indicating that the incentive cannot be refunded and indicating one or more potential causes. Responsive to receipt of this notification request, the social media interface retrieves information descriptive of preferred communication channels associated with the purchaser from the user information data store via the data access engine and sends the notifications according to the preferred communication channels.

Next in the act 724, the incentive engine retrieves, via the data access engine, any additional contribution amounts provided by merchants and associated with the incentive. For each contribution amount retrieved, the incentive engine also retrieves and inspects, via the data access engine, information stored within the incentive information data store that is descriptive of payment options associated with the incentive. If the payment options indicate that the merchant was charged in response to linking of the incentive to the recipient's method of payment, the incentive engine transmits a request to the financial systems interface to debit the intermediate account associated with the incentive by an amount equal to the contribution amount less any portion of the contribution amount redeemed prior to the expiration of the incentive and to credit an account associated with the merchant, such as the method of payment used to fund the incentive, by an amount equal to the contribution amount less any portion of the contribution amount redeemed prior to the expiration of the incentive. In situations where the financial systems interface is unable to credit the method of payment used to fund the incentive (e.g. where the method of payment has been closed), the financial systems interface transmits a request to the social media interface to send a notification to the merchant indicating that the incentive cannot be refunded and indicating one or more potential causes. Responsive to receipt of this notification request, the social media interface retrieves information descriptive of preferred communication channels associated with the merchant from the user information data store via the data access engine and sends the notifications according to the preferred communication channels.

It is to be appreciated that, in at least some embodiments, the incentive engine does not refund transaction fees for expired incentives. However, in other embodiments, the incentive engine may refund a transaction fees, or a portion thereof, in the act 724. Thus embodiments are not limited to a particular policy regarding refunds of transaction fees.

In some embodiments, the incentive engine also transmits a request to the social media interface to send a notification to the recipient indicating that the incentive has been refunded and that the recipient has the option of forwarding the incentive to another user. In some embodiments, the incentive engine is configured to waive the transaction fee normally associated with purchasing an incentive, where the purchaser is forwarding a refunded incentive. The notification may further include a link to the purchaser interface. Next, the incentive management system terminates the process 700. The incentive engine may also transmit a request to the social media interface to send a notification to the recipient indicating that the incentive is about to expire and may be refunded if not redeemed by the recipient.

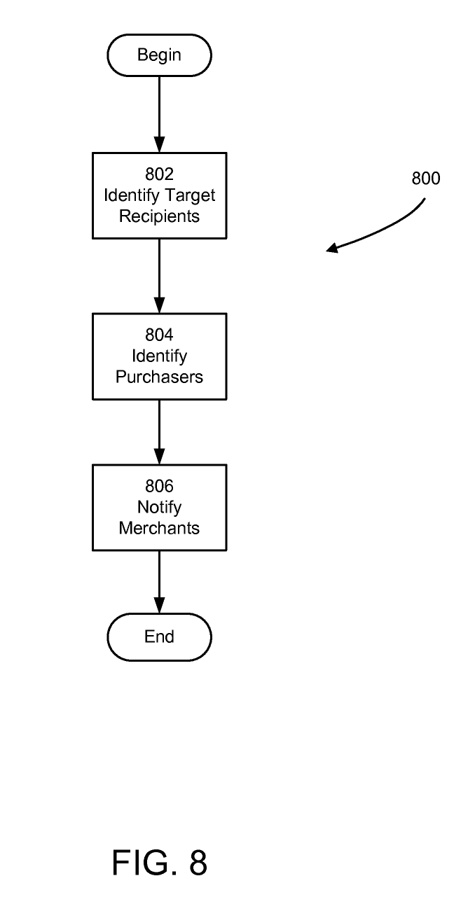

According to some embodiments, an incentive management system, such as the incentive management system 122 described above with reference to FIGS. 1 and 2, performs processes that provide merchants with timely notifications indicating that a historically favorable marketing period is about to transpire. One example of such a notification process is illustrated in FIG. 8. According to the embodiment illustrated in FIG. 8, a notification process 800 includes acts of identifying target recipients, identifying purchasers who historically purchase incentives for the target recipients, and notifying merchants.

The notification process 800 begins with act 802. In the act 802, an incentive engine, such as the incentive engine 226 described above with reference to FIG. 2, identifies in conjunction with a data access engine, such as the data access engine 228 described above with reference to FIG. 2, recipients who historically redeem more than a threshold value of incentives. This threshold value may be a configurable parameter and may be expressed as a percentage value or a currency value, among types of values. In act 804, the incentive engine, in conjunction with the data access engine, identifies purchasers who have historically purchased incentives for the recipients identified in the act 802. In the act 806, the incentive engine, in conjunction with the data access engine, generates a request to a social media interface, such as the social media engine 220 described above with reference to FIG. 2, to send a notification to merchants subscribing to a notification service of dates of importance to the recipients identified in the act 802. In this way, merchants are notified of dates of importance, such as holidays, birthdays, etc., associated with recipients of incentives who make purchases based on the incentives at a favorable rate. The merchants may wish to alter the incentives they make available for purchase or their approach to contributing to purchased incentives based on this information.

Processes 700 and 800 each depict one particular sequence of acts in a particular example. The acts included in these processes may be performed by, or using, one or more computer systems specially configured as discussed herein. Some acts are optional and, as such, may be omitted in accord with one or more examples. Additionally, the order of acts can be altered, or other acts can be added, or various combinations of acts may be utilized, without departing from the scope of the systems and methods discussed herein. Furthermore, as discussed above, in at least one example, the acts are performed on a particular, specially configured machine, namely an incentive management system configured according to the examples and embodiments disclosed herein.

U.S. patent application Ser. No. 13/197,279, entitled “CONSUMER OFFER REDEMPTION METHODS AND SYSTEMS,” filed Aug. 3, 2011 is hereby incorporated herein by reference in its entirety.

Having thus described several aspects of at least one example, it is to be appreciated that various alterations, modifications, and improvements will readily occur to those skilled in the art. For instance, examples and embodiments disclosed herein may also be used in other contexts. For example, although disclosed a being a computer-implemented method of gifting through social media, the method could also be used to apply the gift of an incentive offer directly to an existing, physical gift card. Such alterations, modifications, and improvements are intended to be part of this disclosure, and are intended to be within the scope of the examples discussed herein. Accordingly, the foregoing description and drawings are by way of example only.

What is claimed is:

1. A computer-implemented method of providing a gift of an incentive from a purchaser to a recipient, the method comprising:
(a) storing information on the purchaser in an incentive processing system;
(b) generating one or more incentives using the incentive processing system;
(c) using the incentive processing system to present at least one incentive to the purchaser;
(d) receiving a request from the purchaser using the incentive processing system to accept one of the incentives for gifting to the recipient;
(e) gifting the accepted incentive by transferring the monetary value of the accepted incentive to an intermediary account owned by a third-party;
(f) using the incentive processing system to notify the recipient of the gifted incentive;
(g) receiving notification of acceptance of the gifted incentive by the recipient from the incentive processing system;
(h) linking the gifted incentive to a recipient payment instrument using the incentive processing system; and
(i) crediting the monetary value of the gifted incentive to the recipient by transferring the monetary value from the intermediate account to the recipient payment instrument using a financial management system automatically upon receiving notification that the gifted incentive has been redeemed by the recipient using the recipient payment instrument.

2. The computer-implemented method of claim 1, wherein the incentive processing system includes an incentive management system having a purchaser interface component and a recipient interface component, and wherein the incentive offer is presented to the purchaser and the request from the purchaser to purchase the incentive is made using the purchaser interface component, and wherein the notification of acceptance of the incentive offer by the recipient and linking the incentive offer to the payment instrument of the recipient is carried out using the recipient interface component.

3. The computer-implemented method of claim 2, wherein information relating to the purchaser and information relating to the recipient is stored in a user information data store of the incentive processing system.

4. The computer-implemented method of claim 3, further comprising the step of transferring a request to the recipient interface component to link the gifted incentive to the recipient payment instrument stored in the user information data store, and wherein in response to receiving the linking request, a link between the gifted incentive and the recipient payment instrument is recorded.

5. The computer-implemented method of claim 2, wherein the purchaser interface component and the recipient interface component are configured as browser-based and are rendered by a web browser executing on at least one computer system.

6. The computer-implemented method of claim 2, wherein the purchaser interface component and the recipient interface component are implemented within a social media system.

7. The computer-implemented method of claim 1, further comprising the step of receiving transaction activity associated with the linked recipient payment instrument from the financial management system to determine if the recipient has redeemed the gifted incentive.

8. The computer-implemented method of claim 1, wherein the financial management system includes a financial systems interface configured to exchange information with one or more external financial systems, the information exchanged via the financial systems interface enabling debiting of an account held by the purchaser, transferring the debited amount to the intermediary account, and crediting the recipient payment instrument.

9. The computer-implemented method of claim 1, wherein the one or more incentives are defined by one or more merchants using a merchant interface component of the incentive processing system.

10. The computer-implemented method of claim 9, wherein the merchant defined incentives include terms and conditions as a prerequisite to redemption.

11. The computer-implemented method of claim 1, further comprising the step of adding value to the accepted incentive using contributions from a third-party.

12. The computer-implemented method of claim 11, wherein the third-party is a merchant.

13. The computer-implemented method of claim 11, wherein the added value is selected from the group consisting of a monetary value, a percentage discount, or a product reward.

14. The computer-implemented method of claim 1, further comprising the step of debiting a purchaser payment account as payment for the incentive.

15. The computer-implemented method of claim 14, wherein the purchaser payment account comprises a credit card account, a debit card account, an online money transfer account, a mobile payment account, a virtual money account, or a rewards or points account.

16. A computer system comprising:
a memory;
at least one processor linked to the memory;
a purchaser interface component executed by the at least one processor and configured to receive a request from a purchaser user interface to purchase an incentive having a redemption amount and being subject to at least one redemption condition;
a recipient interface component executed by the at least one processor and configured to receive a request to link the incentive to a recipient payment instrument; and
an incentive engine component executed by the at least one processor and configured to:
(a) request that the intermediate account be credited by the redemption amount;
(b) determine that the at least one redemption condition is satisfied;
(c) request that the intermediate account be debited by the redemption amount;
(d) request that the recipient payment instrument be credited by the redemption amount.

17. The computer system of claim 16, further comprising a merchant interface component executed by the at least one processor and configured to receive requests for incentive information from a merchant user interface and to provide information descriptive of one or more incentives associated with the merchant to the merchant user interface.

18. The computer system of claim 17, wherein the merchant interface component is configured to receive requests to contribute to the incentive from the merchant user interface.

19. The computer system of claim 16, further comprising a merchant interface component executed by the at least one processor and configured to provide one or more bidding screens to one or more merchants through a merchant user interface.

20. The computer system of claim 19, wherein the one or more bidding screen receives bids in the form of requests to contribute to incentives and displays groups of contribution requests having similar incentive characteristics to the one or more merchants through the merchant user interface.

21. The computer system of claim 16, further comprising a social media interface component executed by the at least one processor and configured to exchange information with one or more social media networking systems.

22. The computer system of claim 21, wherein the information exchanged with the one or more social media networking systems includes information descriptive of a purchaser of the incentive and information descriptive of a recipient of the incentive.

23. The computer system of claim 21, wherein the information exchanged with the one or more social media networking systems includes information descriptive of incentives purchased, linked, and redeemed to users of the social media networking systems.

24. The computer system of claim 16, further comprising an incentive engine component executed by the at least one processor and configured to transmit a request to a financial systems interface to debit a purchaser's method of payment by an amount equal to the incentive redemption amount plus any applicable transaction fee, and to credit an intermediate account associated with the incentive by an amount equal to the redemption amount.
